(19) United States
(12) Patent Application Publication
(10) Pub. No.: US 2013/0159007 A1
(43) Pub. Date: Jun. 20, 2013

(54) INCORPORATING EXTERNAL BUSINESS PROCESS FEATURES INTO A SCENARIO VISUALIZATION OR NAVIGATION TOOL

(71) Applicants: Marianne Brosche, Heidelberg (DE); Jochen Mayerle, Flein (DE); Ulrich Keil, Heidelberg (DE); Joachim Fessler, Grafenberg (DE); Holger Knospe, Wiesloch (DE)

(72) Inventors: Marianne Brosche, Heidelberg (DE); Jochen Mayerle, Flein (DE); Ulrich Keil, Heidelberg (DE); Joachim Fessler, Grafenberg (DE); Holger Knospe, Wiesloch (DE)

(21) Appl. No.: 13/326,052

(22) Filed: Dec. 14, 2011

(51) Int. Cl. G06Q 99/00

(52) U.S. Cl. 705/1.1

(57) ABSTRACT

External transactional data relating to a completion status of an external business process feature of a specific business scenario instance supported by a business software architecture can be received and persisted at a repository. The business scenario can include business process features that include the external business process feature, which can be unsupported by a core software platform of the architecture. Navigation and work panes can be concurrently displayed to include first user interface elements arranged in a linear progression to represent the business process features in the linear sequence and second user interface elements corresponding to functionality related to a currently selected one of the plurality of business process features, respectively. A first user interface element corresponding to the external business process feature can be associated with a current status indicator showing a completion status of the external business process feature calculated based on the external transaction data.

### CROSS-REFERENCE TO RELATED APPLICATIONS

The current application is related to the following co-pending and co-owned U.S. patent applications, the disclosure of each of which is incorporated herein in its entirety: [[Attorney docket nos. 34874-774F01US/2011P00201US, 34874-760F01US/2011P00149US, 34874-761F01US/2011P00163US, 34874-763F01US/2011P00166US, 34874-764F01US/2011P00167US, 34874-766F01US/2011P00169US, 34874-768F01US/2011P00171US, 34874-769F01US/2011P00172US, 34874-770F01US/2011P00173US, 34874-771F01US/2011P00174US, 34874-772F01US/2011P00175US, 34874-773F01US/2011P00198US, and 34874-781F01US/2011P00363US]].

### TECHNICAL FIELD

The subject matter described herein relates generally to enhancing user interaction with, and navigation among, features, functions, controls, and the like of an integrated software suite, such as for example an enterprise resource planning solution.

### BACKGROUND

Currently available business software solutions, such as for example enterprise resource planning (ERP) systems, generally do not offer users a convenient mechanism to obtain a overview of or to even navigate through the multiple feature sets of such a system guided by a sequence of business processes, process steps, tasks, sub-processes, and other business process features necessary to complete a specific instance of a business scenario with which the user is associated (e.g. as a supervisor, party responsible for one or more tasks, etc.). Further complications can arise with business process features that are provided by third party software solutions (e.g. external service providers). A feature of many business software (e.g. ERP) solutions that many customers find attractive is the ability to designate a set of business functions to be performed by third party software that is accessible from within a core software platform provided by the ERP or other business software solution.

Many users miss or do not fully internalize the lessons of guidance and orientation programs. In addition, a user may be unaware that he or she is actually participating in a concrete business process or business scenario and, hence, can easily become disoriented in a feature-rich system. This inability to “see the forest for the trees” can hinder resolution of issues that might cause an instance of the business scenario to stall or otherwise deviate from a standard template for the business scenario.

### SUMMARY

In one aspect, a method includes receiving external transactional data during runtime relating to a completion status of an external business process feature that is part of a specific instance of a business scenario represented by a scenario model. The business scenario includes a plurality of business process features that in turn include the external business process feature, which is unsupported by a core software platform of a business software architecture. The core software platform supports at least one other business process feature in the plurality of business process features. The received external transactional data is persisted at a repository. A navigation pane and a work pane are displayed concurrently in a user interface. The navigation pane includes a plurality of first user interface elements arranged in a linear progression to represent the plurality of first business process features in the linear sequence, and the work pane includes a plurality of second user interface elements corresponding to functionality related to a currently selected one of the plurality of business process features. A current status indicator showing a completion status of the external business process feature is associated with at least one of the plurality of first user interface elements in the navigation pane that corresponds to the external business process feature. The completion status is calculated based on the external transaction data.

In some variations one or more of the following features can optionally be included in any feasible combination. The external transactional data can optionally be received from an application external to the core software platform, and the receiving can optionally include receiving pushed or pulled data from the application via an application programming interface provided by the core software platform. The external transactional data can optionally include manually entered data received from a user via a user interface feature associated with the external business process feature. The user interface feature can optionally include a completion-indicating feature. The process model can optionally include a linearized representation of the first business scenario in which the plurality of business process features are arranged in a linear sequence. A user selection of a different one of the first plurality of user interface elements corresponding to a different one of the plurality of business process features that the currently selected one can optionally be received, and the work pane can optionally be changed to include a plurality of third user interface elements corresponding to functionality provided by one or more feature modules of the business software architecture related to the different one of the plurality of first business process features. A visual indicator identifying one of the plurality of first user interface elements corresponding to the currently selected one of the plurality of first business process features can optionally be provided in the navigation pane. A change to the scenario model, which can optionally include at least one of one or more of rearrangement of an order of two or more of the plurality of business process features, addition of a new external business process feature, deletion of one of the plurality of business process features, and re-definition of an aspect of one of the plurality of business process features, can optionally be received via a second user interface, and the change can be saved to the scenario model.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, additional value can be added to process visualization in business software by enabling a user to include all process-specific or scenario-specific steps, including status information, in a single unified visualization or navigation tool and can thus adapt the scenario or process to their needs. A process visualization or navigation tool can thereby be made more flexible with regard to a specific customer situation such that the business process and/or business scenario are displayed to a user and also used in a manner consistent with the map displayed by the visualization or navigation tool. This result can be accomplished even when the core ERP system does not directly support or implement all of the relevant process steps or sub-processes in a business process or business scenario.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a process flow diagram illustrating aspects of a method having one or more features consistent with implementations of the current subject matter;

FIG. 2 shows a screenshot of a user interface;

FIG. 3 shows another screenshot of a user interface;

FIG. 4 is a diagram illustrating aspects of a system showing features consistent with implementations of the current subject matter;

FIG. 5 is a diagram illustrating aspects of a system showing features consistent with implementations of the current subject matter; and

FIG. 6 is a diagram illustrating a data repository showing features consistent with implementations of the current subject matter.

When practical, similar reference numbers denote similar structures, features, or elements.

### DETAILED DESCRIPTION

A scenario navigation or visualization tool, e.g. one that is displayed in a navigation pane concurrently with user interface elements relating the business process features of a business scenario, can provide an integrated, readily accessible framework for navigating through a specific instance of a business scenario while that business scenario is in-progress and can also provide, for example via text boxes, graphics, links, and other user interface elements, current status information relating to progress toward completing each of several business process features required for completion of the business scenario instance.

Generally, business scenarios or processes supported by a core software platform of a business software architecture, ERP system, or the like are defined to include only those business process features that can be assigned to activities that can be executed by a user using features supported by the core software platform user can execute in the system. However, it is not common for a real-world instance of a business scenario to include one or more business process features that at least partially rely on the completion of activities that are either entirely external to a computing system (e.g. making copies and placing them in a physical file, placing a follow-up phone call to a customer or delivery service or the like to verify satisfaction with or completion of a task, or the like). Such business process features may be carried out by hand or via stand-alone tools (e.g. phone, email, videoconferencing, etc.), or they may involve the use of software tools that are not directly integrated into the core software platform. Nonetheless, they can constitute an essential part of the business scenario. Currently available solutions do not include functionality for tracking and presenting the completion status of such external business process features.

To address these and potentially other issues with currently available solutions, methods, systems, articles of manufacture, and the like consistent with one or more implementations of the current subject matter can, among other possible advantages, provide the ability to include “external” business process features into a scenario navigation or visualization tool, for example a navigation pane provided as part of a business software solution, ERP system, or the like to thereby present to users a seamless documentation of business scenarios and processes as they are practiced in their organization. Such an integrated tool can be advantageous for training purposes as well as in streamlining and improving efficiency of day-to-day tasks relating to completion of business process steps or sub-processes. A user can be offered a seamless scenario integration display and navigation or visualization of the business process or business scenario as it applies to whether or not the activities are implemented in the core software platform that provides the integrated user interface for core features, features provided by one or more external service providers linked to the core software platform, and features that are performed external to the business software solution, ERP system, or the like.

A scenario landscape for an organization can refer to a set including all or some of the business scenarios and/or business processes characterizing an organization's operations. In general a business scenario can includes one or more business processes, process steps, or other business process features. Business process features can include, but are not limited to, one or more of business processes, process steps, sub-processes, tasks, activities, and the like. The business scenarios and business processes can be managed, and tasks relating to the completion of one or more steps of the business processes can be supported by, one or more feature modules of a business software architecture, such as for example an enterprise resource planning (ERP) system. The terms “instance of a business process,” “instance of a business scenario,” and similar descriptive terminology is intended to refer to a specific execution of a business process or a business scenario, respectively. For example, for a business scenario relating to sale of a product, each order taken and filled for that product can be considered as an instance of the business scenario. A business configuration can be a set of business scenarios including sets of business processes or business process features supported by the business software architecture and optionally customized to reflect the actual, real-life business functions (e.g. end-to-end business processes) performed by employees or other organization members on a recurring basis. A business configuration for an organization customer of a business software architecture is usually set up upon initial installation with occasional modifications or updates provided to reflect changes to the underlying real-life processes and procedures. Such a business configuration is typically constructed like a catalog, and its functions can be structured according to business areas, packages, topics and options. Once the initial business configuration is set up, all decisions are made, and the scoping is done, the business software architecture is ready for productive usage.

Implementations of the current subject matter can enable inclusion by a user of external business process features in a business scenario navigator or other software-based scenario visualization tool. A scenario or process visualized using such a tool can be extended via an editor, so that users can include additional business process features. □ An external business process feature can be linked to data outside of a business software solution, ERP system, or the like via the editor and can exhibit similar behavior to internal business process features. For example, the navigation or visualization tool can display status information (e.g. done, in-progress, ready to be executed, not ready to be executed, waiting on completion of other steps or actions by other users, etc.) relating to added external business process features just as it does for internal business process features.

In case the activity is implemented by a piece of software that offers a remote callable service of some kind, the external program can be linked, parameters can be passed, and the application can be launched for that activity, so that the user still experiences a navigation feature even though the application providing the external business process features is not part of the cores platform module(s) of the business software solution, ERP system, or the like. □ The actual processing status of the activity can be derived from one or more rules defined by the user via the editor. At run time of the business scenario, the business software solution, ERP system, or the like can provide an API that allows external software systems to publish events and status information to the business software solution, ERP system, or the like. This information can be persisted, for example at a metadata repository system (MDRS), and used to calculate and display the status of external business process features. Persisting the status information at the business software solution, ERP system, or the like enables display via the navigation or visualization tool of a current or at least a last known status of the business process features involving external systems even during periods of unavailability of one or more of the external systems.

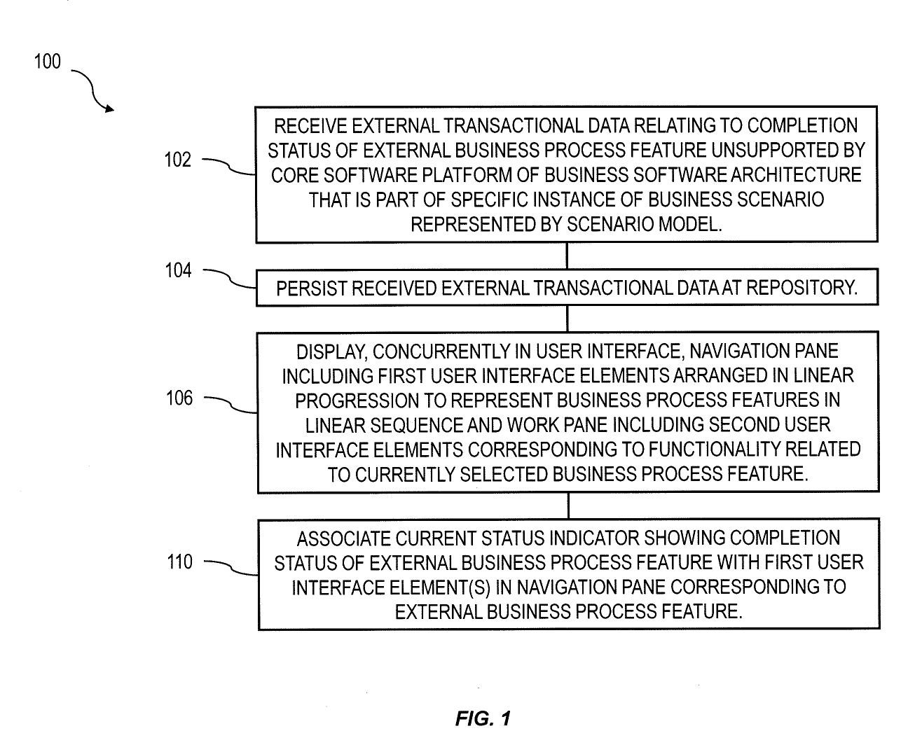

FIG. 1 shows a process flow chart 100 illustrating a method having one or more features consistent with implementations of the current subject matter. At 102, external transactional data relating to a completion status of an external business process feature that is part of a specific instance of a business scenario represented by a scenario model are received during runtime. The business scenario includes a plurality of business process features that includes the external business process feature. The external business process feature is unsupported by a core software platform of a business software architecture that supports at least one other business process feature in the plurality of business process features. At 104, the received external transactional data are persisted at a repository. A user interface concurrently displays both of a navigation pane and a work pane at 106. The navigation pane includes a plurality of first user interface elements arranged in a linear progression to represent the plurality of first business process features in the linear sequence. The work pane includes a plurality of second user interface elements corresponding to functionality related to a currently selected one of the plurality of business process features. At 110, a current status indicator showing the completion status of the external business process feature is associated with at least one of the plurality of first user interface elements in the navigation pane that corresponds to the external business process feature.

Further features of one or more implementations of the current subject matter can include calculating the completion status of the external business process feature based on the external transaction data. If external transactional data are received from an application or software component external to the core software platform, the receiving can include receipt of pushed or pulled data from the application via an application programming interface provided by the core software platform. If the external transactional data are manually entered data, such data can be received from a user via a user interface feature (e.g. a completion-indicating user interface feature such as a check box, radio button, pull-down menu, text box, or the like) associated with the external business process feature.

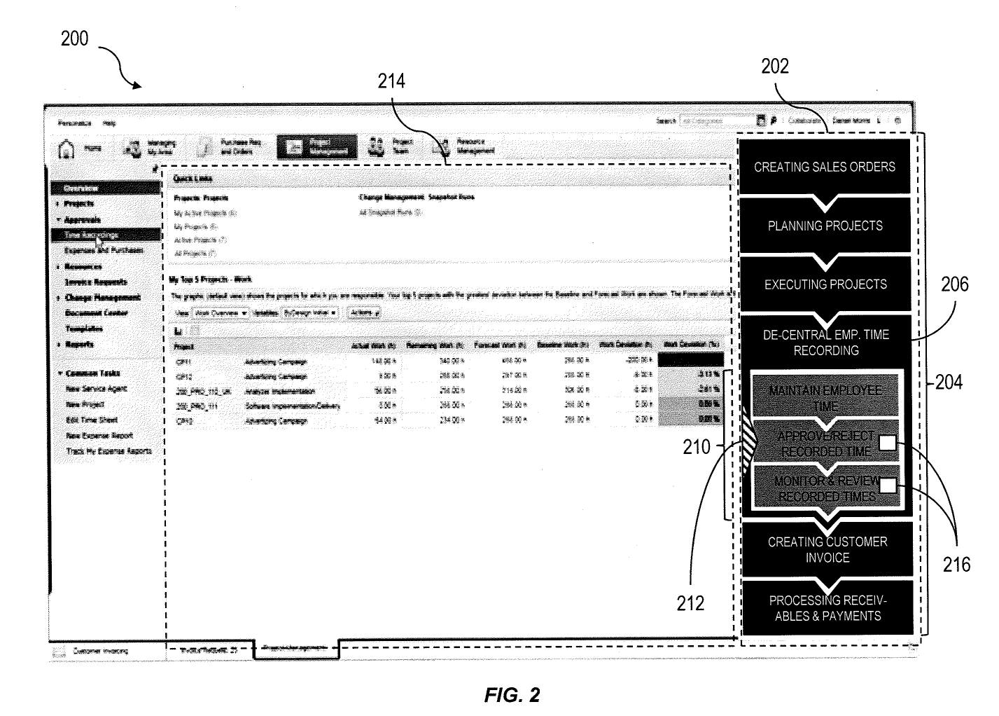

FIG. 2 shows a screenshot 200 of a user interface illustrating features consistent with an implementation of the current subject matter. A navigation pane 202 contains a group of first user interface elements 204 arranged in a linear progression to represent the linear sequence of business process features in the scenario model of the currently actively business scenario. Included in the group of first interface elements 204 is an element 206 representing an intersecting business process as discussed above. In this example, the intersecting business process is “de-central employee time recording.” As a further feature, the business process feature incorporated in this business process can be displayed as a group of business process features 210, which can in various implementations be expanded by interaction of the user with the parent business process user interface element (e.g. by a mouse or trackpad click, a “right click,” a keystroke and mouse combination, or any other mode of receiving user input to elect a function in a user interface). A visual indicator, in this example an arrow icon 212 can be displayed to indicate which business process feature of the business process is currently being worked on. Second user interface elements representing one or more functions, features, etc. of a feature module of the business software architecture can be concurrently displayed in a work pane 214.

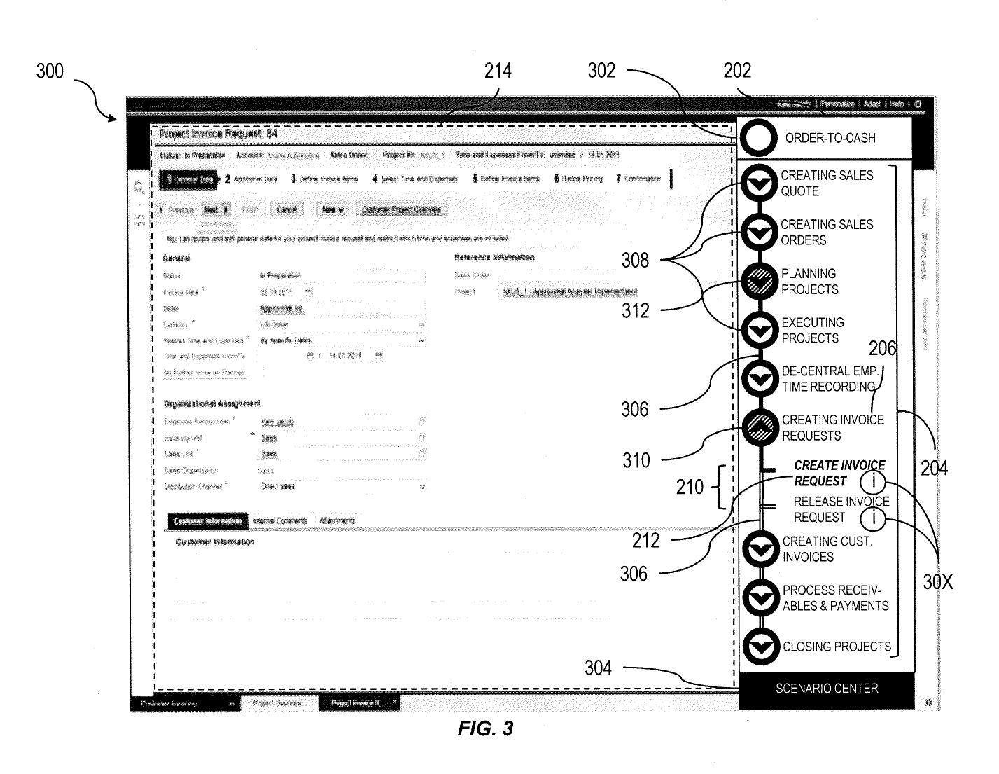

FIG. 3 shows another screenshot 300 of a user interface illustrating features consistent with an implementation of the current subject matter. As in FIG. 2, a navigation pane 202 and a work pane 214 are concurrently displayed. A plurality of first user interface elements 204 are displayed in the navigation pane 202 and arranged in a linear progression to represent the linear sequence of business process features in the scenario model of the currently actively business scenario. A first user interface element 206 corresponding to a business process having additional business process features can be expanded as shown in FIG. 3 to display additional user interface elements 210 corresponding to the additional business process features. Also as shown in FIG. 3, the currently active business scenario can be identified by one or more scenario identifier user elements 302. A scenario browser user interface element 304 can link to a scenario browser or “scenario center” that displays an overall process map showing intersections between scenarios and providing links to navigate to the other scenarios.

The first user interface elements 204 can be displayed in a manner similar to a transit route map with each business process or business process feature being represented like a stop on the route. In this manner, a familiar visual format can rapidly convey additional information about a current context within a specific instance of the business scenario as well as status information about the various business process features along the “route” to completion of the instance. For example, a route line 306 connecting the “stops” can be presented with a first visual effect (e.g. color, brightness, shade, dots or dashes, etc.) up to the “stop” representing the process step that is currently “active” with related functionality being provided in the work pane 214. The currently active process step can be further indicated using textual or visual cues, such as for example color, shading, font, a highlighting box, etc. As a non-limiting example, the name of the process step displayed in conjunction with the user interface element 212 corresponding to the currently active process step in FIG. 3 is formatted in a bold and italicized font. A different second visual effect can be used for the route line 306 leading to the “stops” past the currently active process step. The icons 308 used to represent the “stops” in the navigation pane can also include visual cues to inform a user about status, information other process steps that are included within the currently displayed process step user interface elements and that can be revealed by a user action to expand the route map, or the like.

For example, the first user interface element 310 representing the “stop” corresponding to the business process 210 can include visual presentation features to indicate that it is currently expanded as shown in FIG. 3, while another first user interface element 312 representing a “stop” corresponding to another expandable business process having additional, currently undisplayed business process features can include visual presentation features to indicate that it is currently not expanded but capable of being expanded.

In some implementations, one or more completion-indicating features 216 can be provided in association with one or more first user interface elements corresponding to process steps whose completion can be indicated by manually entered data. In the example of FIG. 2, the completion-indicating features 216 are check boxes, while in FIG. 3 they are shown as radio buttons. Other features capable of receiving a user input are also within the scope of the current subject matter.

In some implementations, one or more of the business process features can include business process features (e.g. business processes, process steps, tasks, activities, or the like) that are performed via external applications. If data relating to completion of these tasks is received at the core software platform and/or persisted at the repository, current status information relating to completion of such business process features can be presented in a transparent manner such that a user need not be directly informed that the business process features that are performed via external applications. In such an implementation, the first user interface elements can display status information for core software platform-based business process features in a similar manner to status information for external application-based business process features.

In some implementations, a second user interface can be provided to receive a change to the process model, for example to do one or more of one or more of rearrangement of an order of two or more of the plurality of process steps, addition of a new external process step, deletion of one of the plurality of business process features (possibly including an external business process feature previously added), re-definition of an aspect of one of the plurality of business process features, or the like. Changes entered via the second user interface can be saved to the scenario model, which can be stored in a repository.

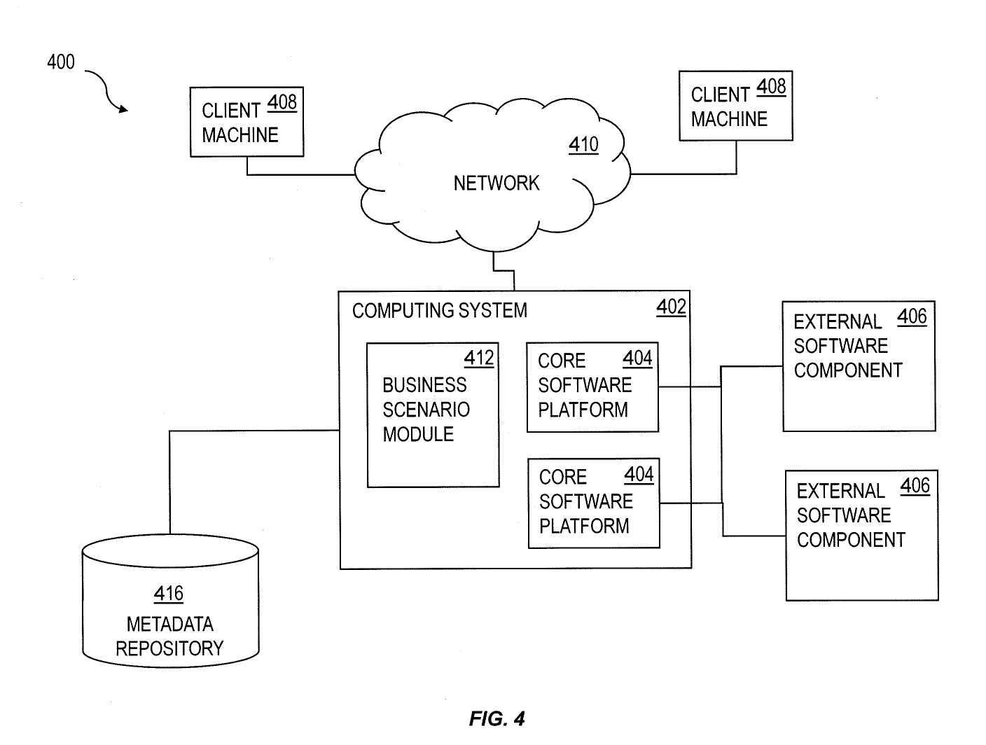

The core software platform of an ERP software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 4 shows a diagram of a system consistent with such an implementation. A computing system 402 can include one or more core software platform modules 404 providing one or more features of the ERP system. The computing system can also aggregate or otherwise provide a gateway via which users can access functionality provided by one or more external service providers 406. Client machines 408 can access the computing system, either via a direct connection, a local terminal, or over a network 410 (e.g. a local area network, a wide area network, a wireless network, the Internet, or the like). A business process guidance and recording module 412 can be hosted on the computing system 402 or alternatively, on an external system accessible over a network connection. The business process guidance and recording module 412 can optionally include one or more discrete software and/or hardware modules that perform operations such as those described herein.

The business process guidance and recording module 412 can access one or more metadata repositories 416 and/or other data repositories that can store the definition of business process as well as data relating to concrete instances of the data objects (e.g. business objects) that are relevant to a specific instance of the business process. In some examples, the definition can optionally be stored as a business object. In some implementations, the business object can include a template definition of a standard business process. The template definition that can optionally be modified via one or more extensions that are stored in the one or more metadata repositories 416.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

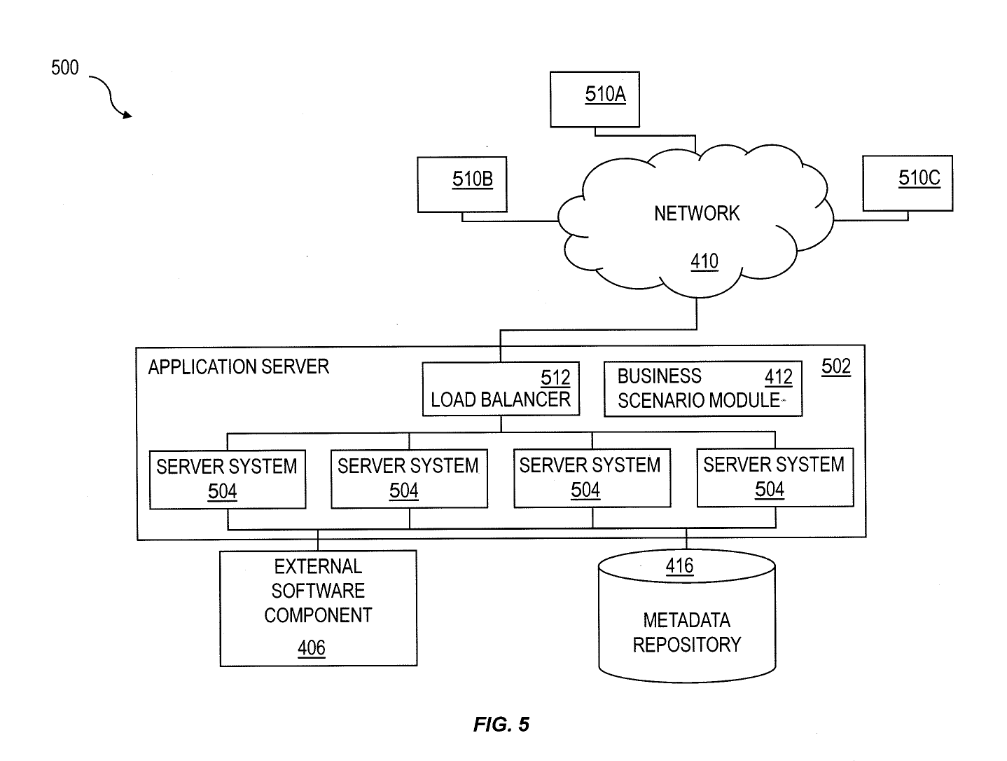

FIG. 5 shows a block diagram of a multi-tenant implementation of a software delivery architecture 500 that includes an application server 502, which can in some implementations include multiple server systems 504 that are accessible over a network 506 from client machines operated by users at each of multiple organizations 510A-510C (referred to herein as “tenants” of a multi-tenant system) supported by a single software delivery architecture 500. For a system in which the application server 502 includes multiple server systems 504, the application server can include a load balancer 512 to distribute requests and actions from users at the one or more organizations 510A-510C to the one or more server systems 504. Instances of the core software platform 404 (not shown in FIG. 5) can be executed in a distributed manner across the server systems 504. A user can access the software delivery architecture across the network using a thin client, such as for example a web browser or the like, or other portal software running on a client machine. The application server 502 can access data and data objects stored in one or more data repositories 416. The application server 502 can also serve as a middleware component via which access is provided to one or more external software components 406 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 502 that includes multiple server systems 504 that handle processing loads distributed by a load balancer 512. Potential benefits from such an arrangement can include, but are not limited to, high and reliably continuous application server availability and minimization of unplanned downtime, phased updating of the multiple server systems 504 to permit continuous availability (one server system 504 can be taken offline while the other systems continue to provide services via the load balancer 512), scalability via addition or removal of a server system 504 that is accessed via the load balancer 512, and de-coupled lifecycle processes (such as for example system maintenance, software upgrades, etc.) that enable updating of the core software independently of tenant-specific customizations implemented by individual tenants.

As in the example illustrated in FIG. 4, the metadata repository 416 can store a business object that represents a template definition of a standard business process. Each individual tenant 510A-510C can customize that standard template according to the individual business process features specific to business of the organization to which that tenant is assigned. Customizations can be stored as extensions in the metadata repository.

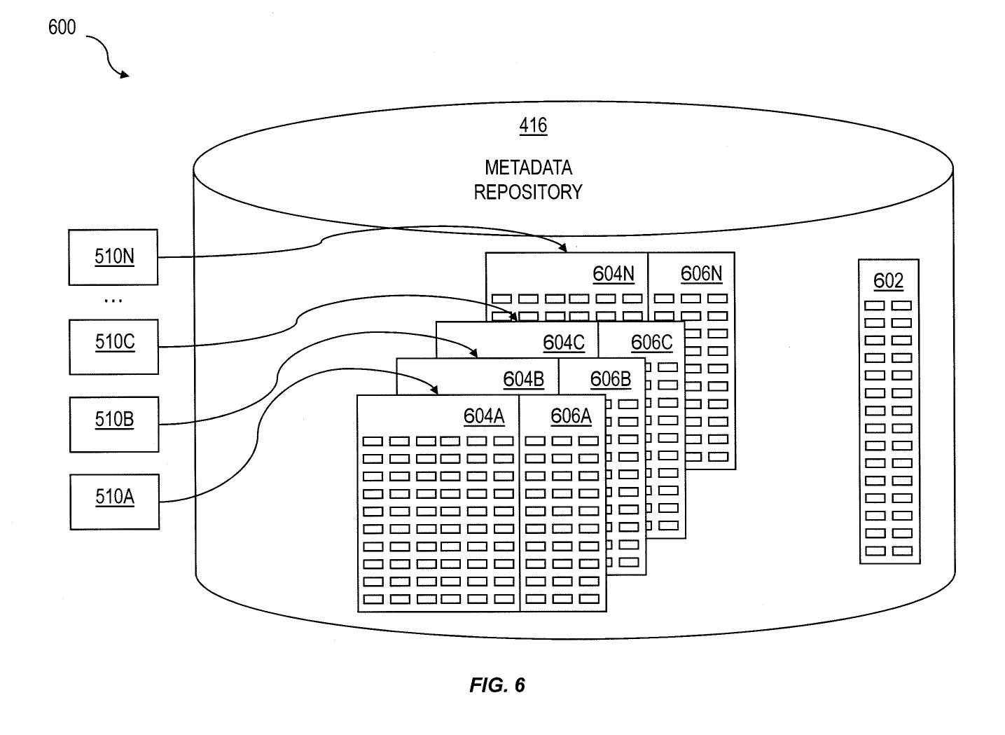

To provide for customization of the business process for each of multiple organizations supported by a single software delivery architecture 500, the data and data objects stored in the metadata repository 416 and/or other data repositories that are accessed by the application server 502 can include three types of content as shown in FIG. 6: core software platform content 602 (e.g. a standard definition of a business process), system content 604 (e.g., and tenant content 606. Core software platform content 602 includes content that represents core functionality and is not modifiable by a tenant. System content 604 can in some examples be created by the runtime of the core software platform and can include core data objects that store concrete data associated with specific instances of a given business process and that are modifiable with data provided by each tenant. The data retained in these data objects are tenant-specific: for example, each tenant 510A-510N can store information about its own inventory, sales order, etc. Tenant content 606A-606N includes data objects or extensions to other data objects that are customized for one specific tenant 510A-510N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 606 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 602 and system content 604 and tenant content 606 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
receiving, during runtime, external transactional data relating to a completion status of an external business process feature that is part of a specific instance of a business scenario represented by a scenario model, the business scenario comprising a plurality of business process features, the plurality of business process features comprising the external business process feature, the external business process feature being unsupported by a core software platform of a business software architecture, the core software platform supporting at least one other business process feature in the plurality of business process features;
persisting the received external transactional data at a repository;
displaying, concurrently in a user interface, a navigation pane and a work pane, the navigation pane comprising a plurality of first user interface elements arranged in a linear progression to represent the plurality of first business process features in the linear sequence, the work pane comprising a plurality of second user interface elements corresponding to functionality related to a currently selected one of the plurality of business process features;
associating, with at least one of the plurality of first user interface elements in the navigation pane that corresponds to the external business process feature, a current status indicator showing a completion status of the external business process feature, the completion status being calculated based on the external transaction data.

2. A computer program product as in claim 1, wherein the external transactional data are received from an application external to the core software platform and wherein the receiving comprises receiving pushed or pulled data from the application via an application programming interface provided by the core software platform.

3. A computer program product as in claim 1, wherein the external transactional data comprise manually entered data received from a user via a user interface feature associated with the external business process feature.

4. A computer program product as in claim 3, wherein the user interface feature comprises a completion-indicating feature.

5. A computer program product as in claim 1, wherein the process model comprises a linearized representation of the first business scenario in which the plurality of business process features are arranged in a linear sequence.

6. A computer program product as in claim 5, wherein the operations further comprise:
receiving a user selection of a different one of the first plurality of user interface elements corresponding to a different one of the plurality of business process features that the currently selected one; and
changing the work pane to comprise a plurality of third user interface elements corresponding to functionality provided by one or more feature modules of the business software architecture related to the different one of the plurality of first business process features.

7. A computer program product as in claim 1, wherein the operations further comprise providing a visual indicator in the navigation pane, the visual indicator identifying one of the plurality of first user interface elements corresponding to the currently selected one of the plurality of first business process features.

8. A computer program product as in claim 1, wherein the operations further comprise:
receiving, via a second user interface, a change to the scenario model, the change comprising at least one of one or more of rearrangement of an order of two or more of the plurality of business process features, addition of a new external business process feature, deletion of one of the plurality of business process features, and re-definition of an aspect of one of the plurality of business process features; and
saving the change to the scenario model.

9. A system comprising:
at least one programmable processor; and
a machine-readable medium storing instructions that, when executed by the at least one processor, cause the at least one programmable processor to perform operations comprising:
receiving, during runtime, external transactional data relating to a completion status of an external business process feature that is part of a specific instance of a business scenario represented by a scenario model, the business scenario comprising a plurality of business process features, the plurality of business process features comprising the external business process feature, the external business process feature being unsupported by a core software platform of a business software architecture, the core software platform supporting at least one other business process feature in the plurality of business process features;
persisting the received external transactional data at a repository;
displaying, concurrently in a user interface, a navigation pane and a work pane, the navigation pane comprising a plurality of first user interface elements arranged in a linear progression to represent the plurality of first business process features in the linear sequence, the work pane comprising a plurality of second user interface elements corresponding to functionality related to a currently selected one of the plurality of business process features;
associating, with at least one of the plurality of first user interface elements in the navigation pane that corresponds to the external business process feature, a current status indicator showing a completion status of the external business process feature, the completion status being calculated based on the external transaction data.

10. A system as in claim 9, wherein the external transactional data are received from an application external to the core software platform and wherein the receiving comprises receiving pushed or pulled data from the application via an application programming interface provided by the core software platform.

11. A system as in claim 9, wherein the external transactional data comprise manually entered data received from a user via a user interface feature associated with the external business process feature.

12. A system as in claim 11, wherein the user interface feature comprises a completion-indicating feature.

13. A system as in claim 9, wherein the process model comprises a linearized representation of the first business scenario in which the plurality of business process features are arranged in a linear sequence.

14. A system as in claim 13, wherein the operations further comprise:
receiving a user selection of a different one of the first plurality of user interface elements corresponding to a different one of the plurality of business process features that the currently selected one; and
changing the work pane to comprise a plurality of third user interface elements corresponding to functionality provided by one or more feature modules of the business software architecture related to the different one of the plurality of first business process features.

15. A system as in claim 9, wherein the operations further comprise providing a visual indicator in the navigation pane, the visual indicator identifying one of the plurality of first user interface elements corresponding to the currently selected one of the plurality of first business process features.

16. A system as in claim 9, wherein the operations further comprise:
receiving, via a second user interface, a change to the scenario model, the change comprising at least one of one or more of rearrangement of an order of two or more of the plurality of business process features, addition of a new external business process feature, deletion of one of the plurality of business process features, and re-definition of an aspect of one of the plurality of business process features; and
saving the change to the scenario model.

17. A computer-implemented method comprising:
receiving, during runtime, external transactional data relating to a completion status of an external business process feature that is part of a specific instance of a business scenario represented by a scenario model, the business scenario comprising a plurality of business process features, the plurality of business process features comprising the external business process feature, the external business process feature being unsupported by a core software platform of a business software architecture, the core software platform supporting at least one other business process feature in the plurality of business process features;
persisting the received external transactional data at a repository;
displaying, concurrently in a user interface, a navigation pane and a work pane, the navigation pane comprising a plurality of first user interface elements arranged in a linear progression to represent the plurality of first business process features in the linear sequence, the work pane comprising a plurality of second user interface elements corresponding to functionality related to a currently selected one of the plurality of business process features;
associating, with at least one of the plurality of first user interface elements in the navigation pane that corresponds to the external business process feature, a current status indicator showing a completion status of the external business process feature, the completion status being calculated based on the external transaction data.

18. A computer-implemented method as in claim 17, further comprising:
receiving a user selection of a different one of the first plurality of user interface elements corresponding to a different one of the plurality of business process features that the currently selected one; and
changing the work pane to comprise a plurality of third user interface elements corresponding to functionality provided by one or more feature modules of the business software architecture related to the different one of the plurality of first business process features.

19. A computer-implemented method as in claim 17, further comprising providing a visual indicator in the navigation pane, the visual indicator identifying one of the plurality of first user interface elements corresponding to the currently selected one of the plurality of first business process features.

20. A computer-implemented method as in claim 17, further comprising:
receiving, via a second user interface, a change to the scenario model, the change comprising at least one of one or more of rearrangement of an order of two or more of the plurality of business process features, addition of a new external business process feature, deletion of one of the plurality of business process features, and re-definition of an aspect of one of the plurality of business process features; and
saving the change to the scenario model.
